(19) United States
(12) Patent Application Publication
(10) Pub. No.: US 2017/0299155 A1
(43) Pub. Date: Oct. 19, 2017

(54) DEVICE FOR CONNECTING A LIGHT FIXTURE TO A SHADE FOR VANITY LIGHTING AND PENDANT LIGHTING

(71) Applicant: RUBEN I. BIBI, NEW YORK, NY (US)

(72) Inventor: RUBEN I. BIBI, NEW YORK, NY (US)

(21) Appl. No.: 15/130,475

(22) Filed: Apr. 15, 2016

(51) Int. Cl. F21V 17/10; F21V 17/18; F21V 1/00

(52) U.S. Cl. CPC F21V 17/105; F21V 1/00; F21V 17/18

(57) ABSTRACT

An attachment device 10 for securing a lighting shade 20 to a lighting fixture 30, wherein the lighting shade 20 has an upper surface 22 for receiving thereon a plurality of magnet members 24, 26, and 28 that form the attachment device 10. The lighting fixture 30 has a connection housing 32 and an engaging surface 34 for engaging the attachment device 10 having magnet member 24, 26, and 28 on the upper surface 22 for retaining the removably connected lighting fixture 30 to the magnet members 24, 26, and 28 on the lighting shade.

### FIELD OF THE INVENTION

The present invention relates to an attachment device for attaching a lighting shade to a lighting fixture.

### BACKGROUND OF THE INVENTION

With regard to lighting fixtures and lighting shades, there have been a number of techniques for removably attaching them to each other. They have drawbacks, including safety, security, difficulty of use and installation. Accordingly, the present invention has provided improvements.

### DESCRIPTION OF THE PRIOR ART

U.S. Pat. No. 5,993,029 to Chambers discloses a prior art lighting fixture having an attachment ring for clamping a globe to a lighting fixture.

### OBJECTS OF THE INVENTION

It is an object of the present invention to provide a safe, secure, and inexpensive attachment device for attaching lighting shades to lighting fixtures.

It is a further object of the present invention to provide ease of use, ease of installation, and ease of removing the lighting shade without damage.

It is a further object of the present invention to provide magnets to removably attach lighting shades to lighting fixtures.

It is a further object of the present invention to attach lighting shades to lighting fixtures using an L-shaped locking attachment.

It is a further object of the present invention to attach lighting shades to lighting fixtures using a key-hole shaped locking attachment.

### SUMMARY OF THE INVENTION

The present invention provides an attachment device 10 for securing a lighting shade 20 to a lighting fixture 30, wherein the lighting shade 20 has an upper surface 22 for receiving thereon a plurality of magnet members 24, 26, and 28 that form the attachment device 10. The lighting fixture 30 has a connection housing 32 and an engaging surface 34 for engaging the attachment device 10 having magnet member 24, 26, and 28 on the upper surface 22 for retaining the removably connected lighting fixture 30 to the magnet members 24, 26, and 28 on the lighting shade 20. Other embodiments are also disclosed.

### BRIEF DESCRIPTION OF THE DRAWINGS

FIG. 1 is a perspective view of the lighting fixture and lighting shade;

FIG. 2 is a perspective view of the lighting shade;

FIGS. 2A and 2B show alternate lighting shades;

FIG. 2C shows the invention with pendant lighting;

FIG. 3 is a front view of FIG. 2;

FIG. 4 is a sectional view of FIG. 2;

FIG. 4A is a sectional view of FIG. 2 showing a bent metal tab;

FIGS. 5, 6, and 7 show additional lighting fixtures using the magnets of the present invention;

FIGS. 8 and 9 show a quick L-shaped lock and magnetic attachment device for attaching the lighting shade and lighting fixture;

FIG. 8A shows the lighting shade assembled with a lighting fixture;

FIGS. 10 and 11 show a key-hole shaped lock and magnetic attachment device for attaching the lighting shade and lighting fixture;

FIG. 11A shows the lighting shade assembled with a lighting fixture; and

FIGS. 12A and 12B show the collar or attachment ring for a ceiling mount for the shade and light fixture.

### DETAILED DESCRIPTION OF THE PREFERRED EMBODIMENT

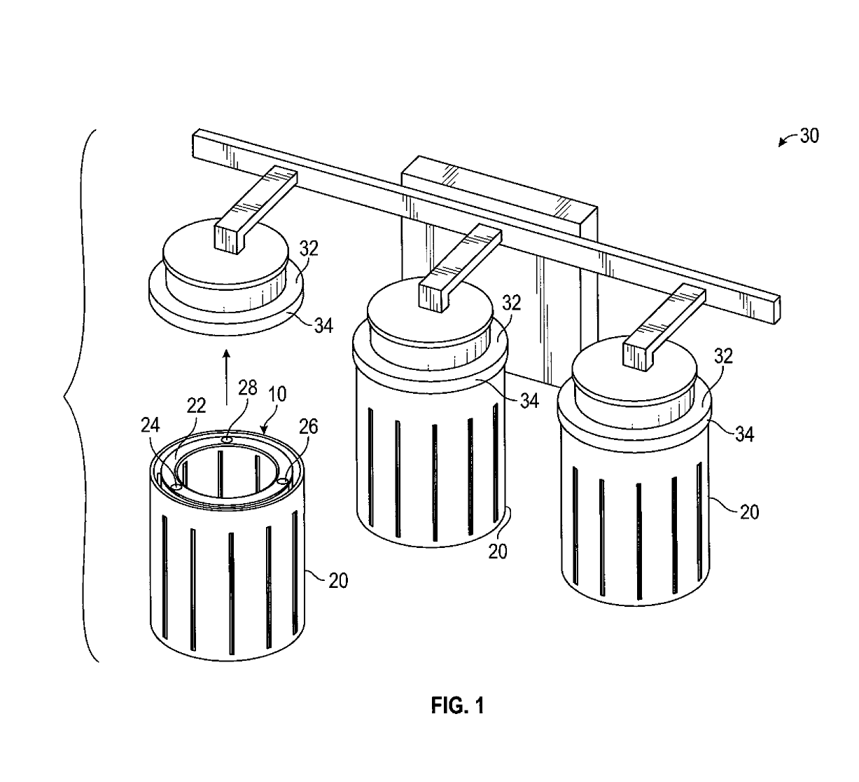

In the first embodiment shown in FIGS. 1 to 7, the present invention provides an attachment device 10 for securing a lighting shade 20 to a lighting fixture 30, wherein the lighting shade 20 has an upper surface 22 for receiving thereon a plurality of magnet members 24, 26, and 28 that form the attachment device 10. The lighting fixture 30 has a connection housing 32 and an engaging surface 34 for engaging the attachment device 10 having magnet member 24, 26, and 28 on the upper surface 22 for retaining the removably connected lighting fixture 30 to the magnet members 24, 26, and 28 on the lighting shade 20.

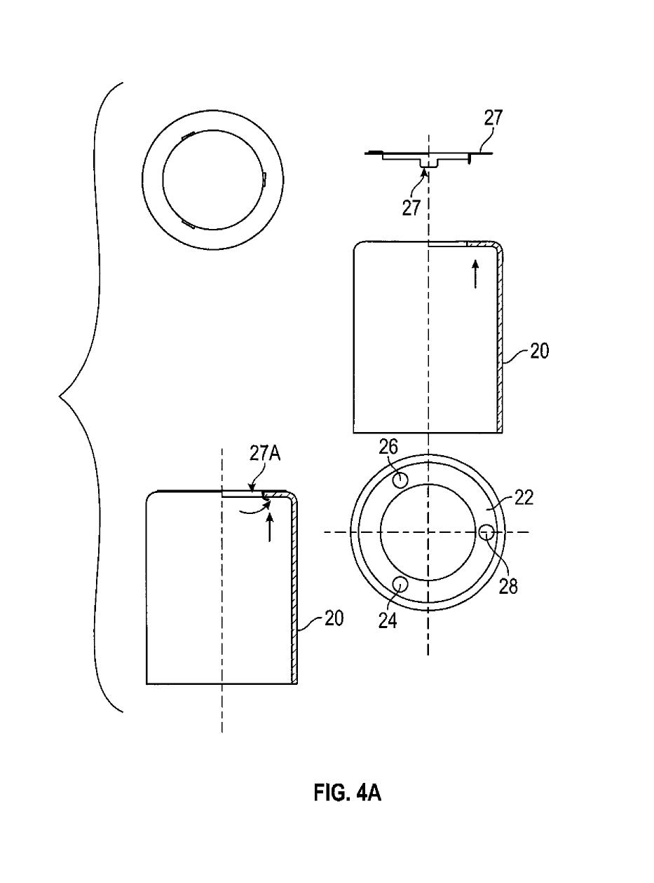

FIG. 4 is a cross sectional view showing that there are 3 L-shaped metal tabs 27 that are bent downwardly to secure the metal ring 29 to the top edge of the glass shade 20 in addition to glue bonding of the tab 27 to the glass shade 20. FIG. 4A shows L-shaped tabs 27A which curve inwardly for extra security in holding the glass shade 20.

The present invention may be used for pendant lighting, vanity lighting, surface flush mounted lighting, outdoor lighting, or ceiling mounted lighting.

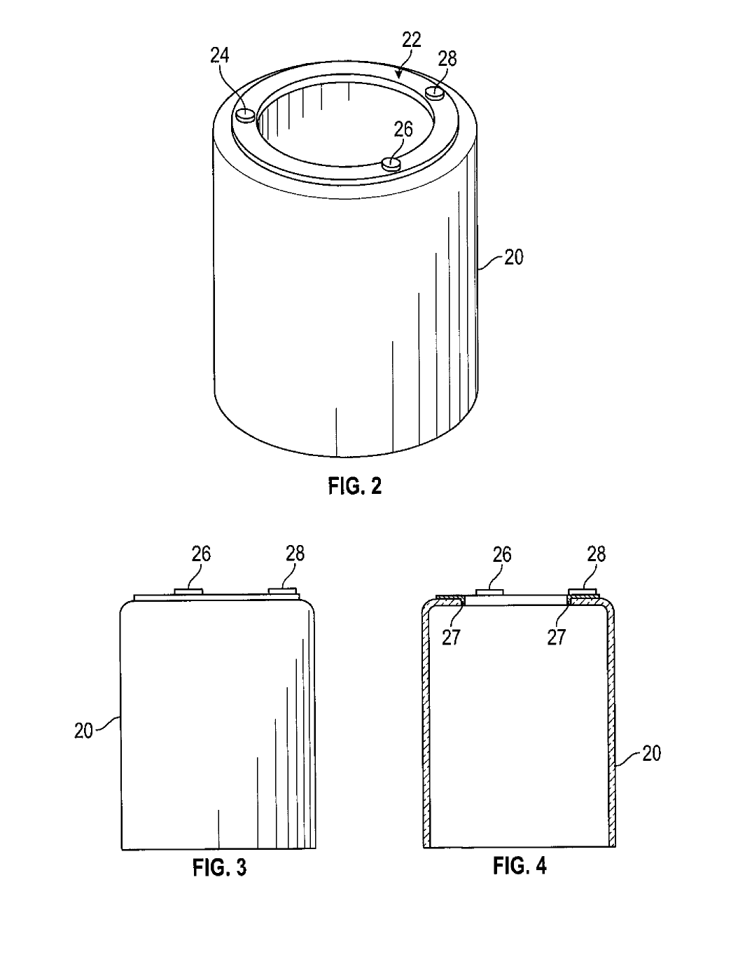

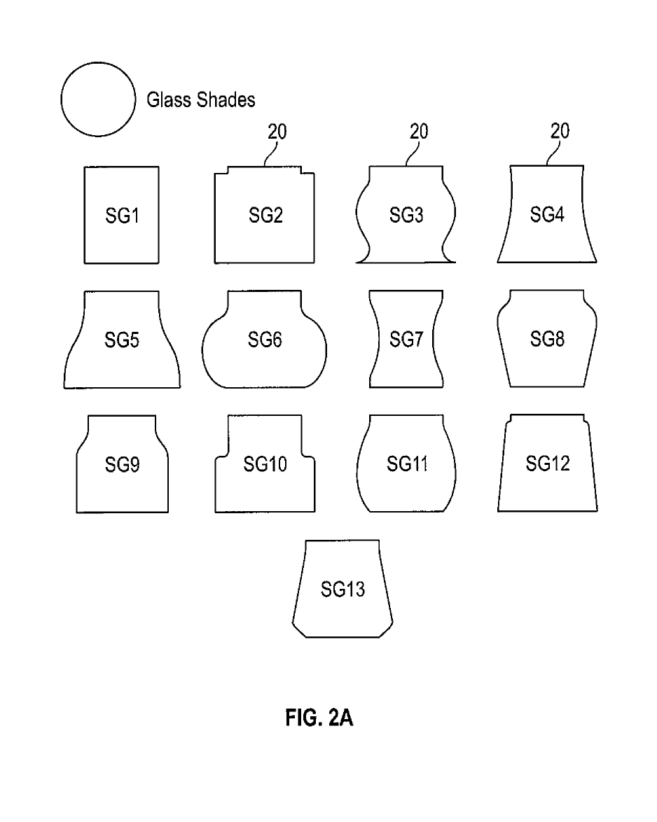

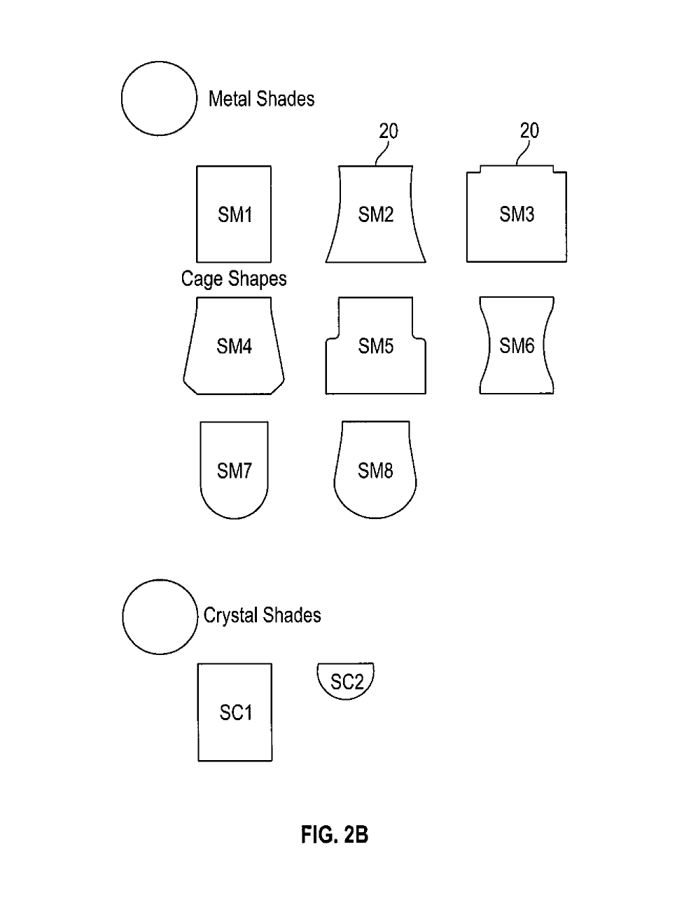

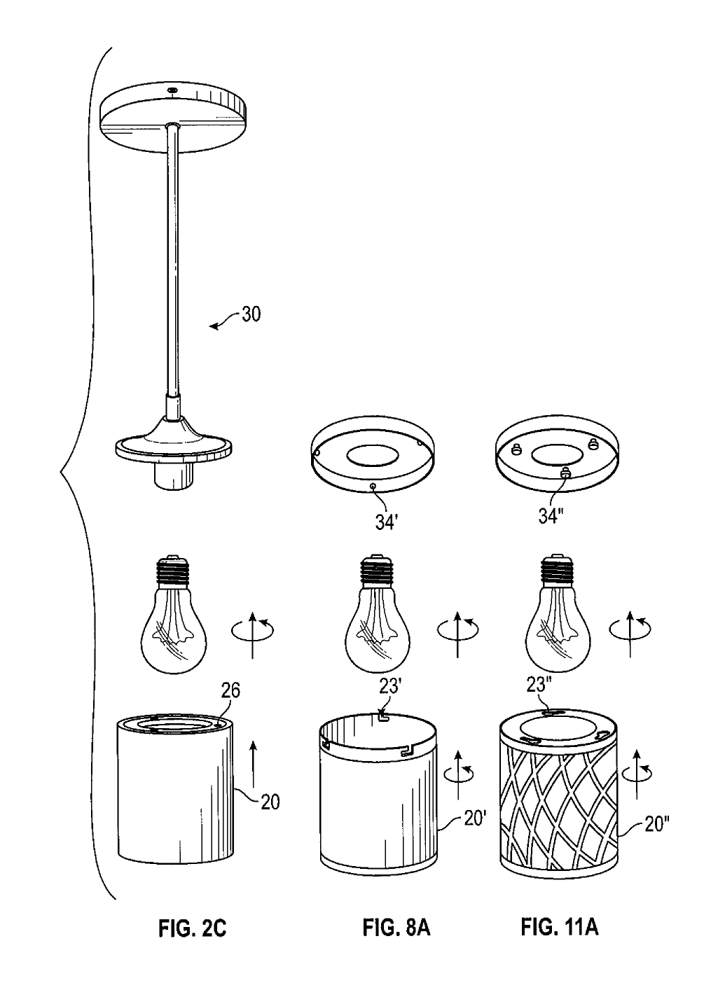

The lighting shade 20 may be of any configuration, and examples are shown in FIGS. 2A and 2B.

Lighting shade 20 and lighting fixture 34 may be of any shape, such as round, square, or other shapes.

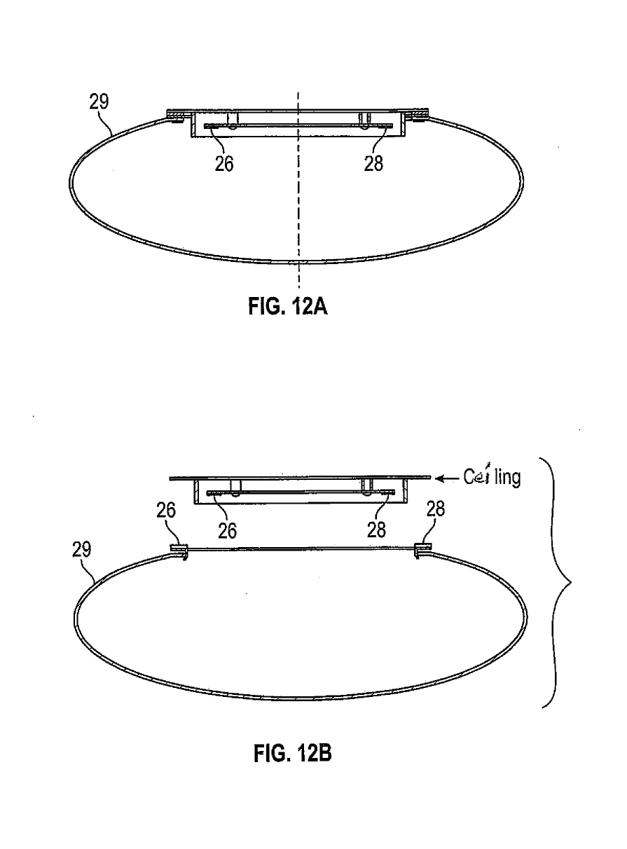

FIGS. 12A and 12B show a metal ring 29 for a ceiling mounted arrangement of the shade and light fixture.

### DETAILED DESCRIPTION OF THE SECOND EMBODIMENT

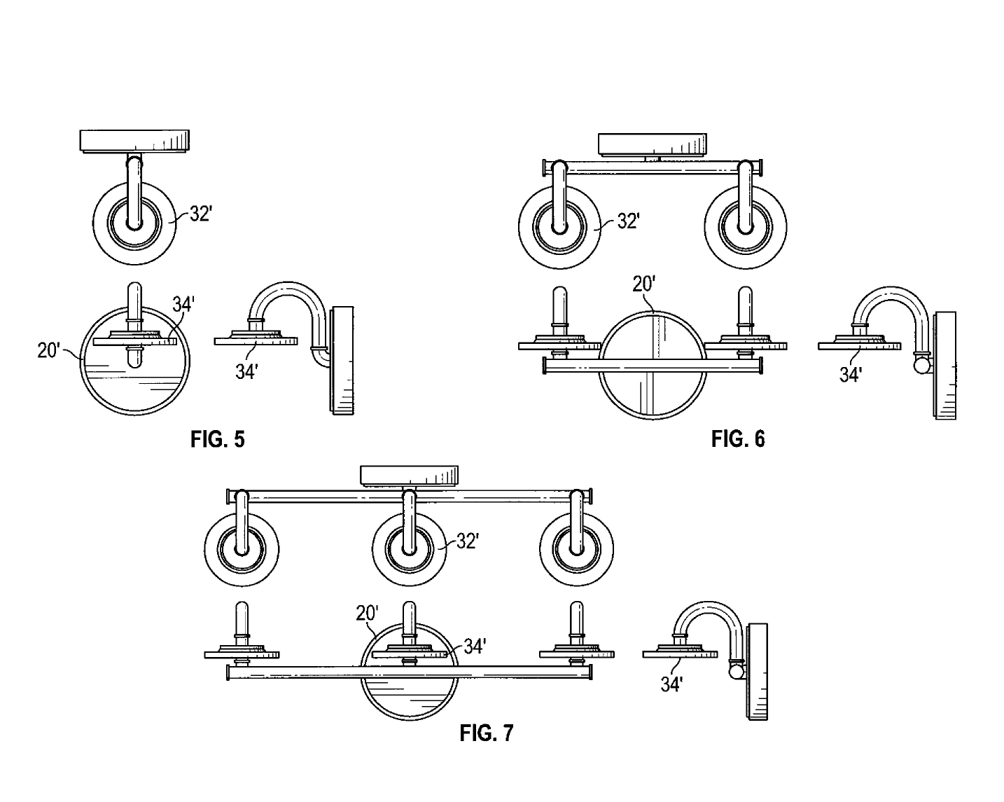

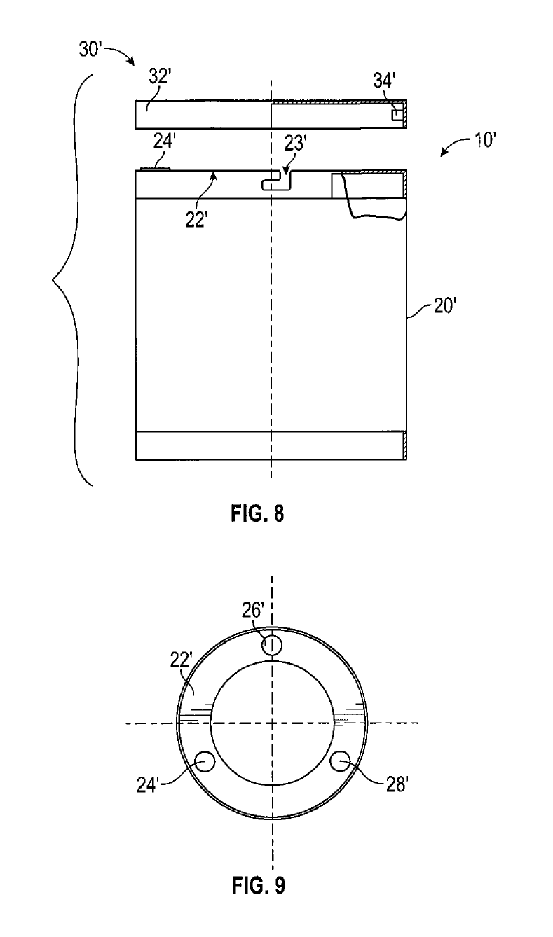

In the second embodiment shown in FIGS. 8 and 9, the present invention also provides an attachment device 10′ for securing a lighting shade 20′ to a lighting fixture 30′, wherein the lighting shade 20′ has a side surface 22′ having L-shaped cutouts 23′ that form the attachment device 10′. The lighting fixture 30′ has a connection housing 32′ and an engaging member 34′ for engaging the L-shaped cutouts 23′ as part of the attachment device 10′. Magnet members 24′, 26′, and 28′ can also be provided on the upper surface 22′ for additional retention of the removably connected lighting fixture 30′ to the L-shaped cutouts 23′ and the magnet members 24′, 26′, and 28′ on the lighting shade 20′.

### DETAILED DESCRIPTION OF THE THIRD EMBODIMENT

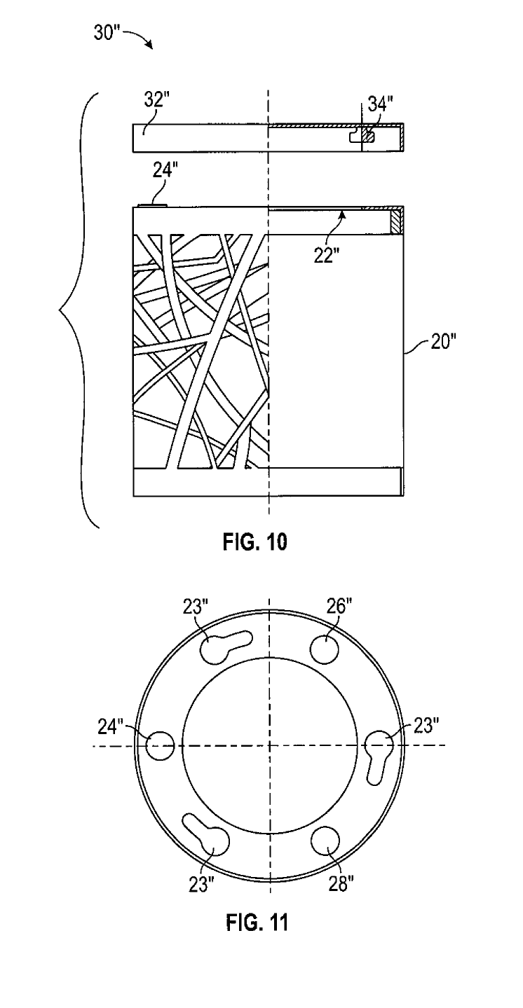

In the third embodiment shown in FIGS. 10 and 11, the present invention also provides an attachment device 10″ for securing a lighting shade 20″ to a lighting fixture 30″, wherein the lighting shade 20″ has an upper surface 22″ having key-hole shaped cutouts 23″ that form the attachment device 10″. The lighting fixture 30″ has a connection housing 32″ and an engaging member 34″ double prime for engaging the key-hole shaped cutouts 23″ as part of the attachment device 10″. Magnet members 24″, 26″, and 28″ can also be provided on the upper surface 22″ for additional retention of the removably connected lighting fixture 30″ to the key-hole shaped cutouts 23″ and the magnet members 24″, 26″, and 28″ on the lighting shade 20″.

### ADVANTAGES OF THE PRESENT INVENTION

An advantage of the present invention is to provide a safe, secure, and inexpensive attachment device for attaching lighting shades to lighting fixtures.

Another advantage of the present invention is to provide ease of use, ease of installation, and ease of removing the lighting shade without damage.

Another advantage of the present invention is to provide magnets to removably attach lighting shades to lighting fixtures.

Another advantage of the present invention is to attach lighting shades to lighting fixtures using an L-shaped locking attachment.

Another advantage of the present invention is to attach lighting shades to lighting fixtures using a key-hole shaped locking attachment.

A latitude of modification, change and substitution is intended in the foregoing disclosure, and in some instances, some features of the invention will be employed without a corresponding use of other features. Accordingly, it is appropriate that the appended claims be construed broadly and in a manner consistent with the spirit and scope of the invention herein.

What is claimed is:

1) An attachment device 10 for securing a lighting shade 20 to a lighting fixture 30, comprising:
a) said lighting shade 20 having an upper surface 22 for receiving thereon a plurality of magnet members 24, 26, and 28 that form said attachment device 10; and
b) said lighting fixture 30 having a connection housing 32 and an engaging surface 34 for engaging said attachment device 10 having magnet member 24, 26, and 28 on said upper surface 22 for retaining said removably connected lighting fixture 30 to said magnet members 24, 26, and 28 on said lighting shade 20.

2) An attachment device 10′ for securing a lighting shade 20′ to a lighting fixture 30, comprising:
a) said lighting shade 20′ having a side surface 22′ having L-shaped cutouts 23′ that form said attachment device 10′; and
b) said lighting fixture 30′ having a connection housing 32′ and an engaging member 34′ for engaging the L-shaped cutouts 23′ as part of said attachment device 10′ for retaining said removably connected lighting fixture 30′ to the L-shaped cutouts 23′ on said lighting shade 20′.

3) An attachment device 10″ for securing a lighting shade 20″ to a lighting fixture 30″, comprising:
a) said lighting shade 20″ having an upper surface 22″ for having formed therein 3 key-hole shaped cutouts 23″ that form said attachment device 10″; and
b) said lighting fixture 30 having a connection housing 32″ and engaging members 34″ for engaging the said key-hole shaped cutouts 23″ as part of said attachment devices 10″ for retaining said removably connected lighting fixture 30″ to said key-hole shaped cutouts 23″ on said lighting shade 20′.
